(19) United States
(12) Patent Application Publication
(10) Pub. No.: US 2025/0296847 A1
(43) Pub. Date: Sep. 25, 2025

(54) ALUMINA PARTICLE MATERIAL AND METHOD FOR PRODUCING SAME, AND ORGANIC SUBSTANCE COMPOSITION

(71) Applicant: ADMATECHS CO., LTD., Miyoshi-shi (JP)

(72) Inventors: Ikuya MATSUE, Miyoshi-shi (JP); Ryoya OKAWA, Miyoshi-shi (JP); Yusuke WATANABE, Miyoshi-shi (JP); Tempo NAKAMURA, Miyoshi-shi (JP)

(73) Assignee: ADMATECHS CO., LTD., Miyoshi-shi (JP)

(21) Appl. No.: 19/231,661

(22) Filed: Jun. 9, 2025

Related U.S. Application Data
(63) Continuation of application No. PCT/JP2023/044235, filed on Dec. 11, 2023.

(30) Foreign Application Priority Data
Dec. 9, 2022 (WO) PCT/JP2022/045487

(51) Int. Cl. C01F 7/026; C08K 9/02

(52) U.S. Cl. CPC C01F 7/026; C08K 9/02

(57) ABSTRACT

A method for producing an alumina particle material according to the present disclosure includes a raw particle material preparation step of preparing a raw particle material containing alumina as a main component, a heating step of preparing a dried raw particle material by maintaining the raw particle material at 100° C. or higher for 5 minutes or more, and a surface treatment step of treating the dried raw particle material subjected to the heating step and having less moisture adsorbed on a surface thereof than that before the heating step, using a surface treatment agent, to mask at least a portion of OH groups present on the surface. Alumina constituting the alumina particle material has OH groups on a surface thereof. Since a large number of water molecules are adsorbed onto the OH groups, the adsorbed moisture is removed through the heating step.

### CROSS REFERENCE TO RELATED APPLICATIONS

The present application is a Continuation application of International Application No. PCT/JP2023/044235, filed on Dec. 11, 2023, the entire contents of which are incorporated herein by reference.

### TECHNICAL FIELD

The present disclosure relates to an alumina particle material and a production method therefor, and an organic substance composition.

### BACKGROUND ART

An alumina particle material is used as a resin composition incorporated in a resin material in applications of electronic materials as an encapsulant and a thermally conductive material (TIM). The alumina particle material to be used as the resin composition is usually subjected to surface treatment in order to improve affinity for resin, etc. (Patent Literatures 1, 2).

### CITATION LIST

### Patent Literature

Patent Literature 1: WO2016/017637
Patent Literature 2: JP2020-066678 (A)

### SUMMARY OF INVENTION

### Technical Problem

In recent years, as the performance of electronic equipment improves, a resin composition for an electronic material is also required to have excellent electric characteristics.

The present disclosure has been completed in view of the above circumstances. An object of the present invention is to provide an alumina particle material and a production method therefor from and with which achieve a resin composition having excellent electric characteristics, and an organic substance composition including the alumina particle material dispersed in an organic substance.

### Solution to Problem

In order to achieve the above object, the present inventors have conducted thorough studies. As a result, the present inventors have found that the electric characteristics of an alumina particle material are improved by reducing moisture in the alumina particle material, particularly, moisture present on a surface thereof, and have completed the following disclosure.

(1) A method for producing an alumina particle material according to the present disclosure achieving the above object includes: a raw particle material preparation step of preparing a raw particle material containing alumina as a main component;
a heating step of preparing a dried raw particle material by maintaining the raw particle material at 100° C. or higher and 300° C. or lower for 5 minutes or more; and
a surface treatment step of treating the dried raw particle material subjected to the heating step and having less moisture adsorbed on a surface thereof than that before the heating step, using a surface treatment agent, to mask at least a portion of OH groups present on the surface.

Alumina constituting the alumina particle material has OH groups on a surface thereof. Since a large number of water molecules are adsorbed onto the OH groups, even if surface treatment was performed using the surface treatment agent, such surface treatment has been found to be insufficient.

That is, the large number of water molecules present on the surface of the alumina inhibit the surface treatment agent from directly reacting with the OH groups present on the surface of the alumina. Thus, immediately after the surface treatment is performed using the surface treatment agent, the quantity of the OH groups present on the surface of the particle is small, and the value of a dielectric loss tangent is maintained low. However, the surface treatment agent that is not bonded directly to the surface of the alumina becomes detached over time, and OH groups reappear on the surface, so that a tendency for the dielectric loss tangent to increase is observed.

Similar to alumina, as an inorganic material to be used for a resin composition for an electronic material, silica has been known. However, a smaller number of water molecules are adsorbed onto OH groups present on the surface of silica than those on the surface of alumina. Thus, a particle material composed of silica is more easily modified through surface treatment. The details will be described using Examples.

Thus, water molecules adsorbed on the alumina particle material are removed before the surface treatment, and then, the surface treatment is performed before water molecules are re-adsorbed, whereby the effect of the surface treatment is sufficiently exhibited.

(2) An alumina particle material according to the present disclosure achieving the above object is a particle material which is spherical and contains alumina as a main component, wherein
a volume average particle diameter is 2.0 μm or less (preferably, less than 0.5 μm),
a specific surface area is 1.5 m²/g or more,
a moisture content resulting after heating from 25° C. to 200° C. is 700 ppm or less by mass,
a dielectric loss tangent is 0.0075 or less, and
the alumina particle material has an organic functional group on a surface thereof.

(3) An organic substance composition achieving the above object includes: the alumina particle material described in the above (1); and
a dispersion medium composed of at least one of an organic resin material and an organic solvent for dispersing the alumina particle material.

### Advantageous Effects of Invention

According to the method for producing the alumina particle material of the present disclosure, as a result of having the above configuration, a large amount of adsorbed moisture usually present on the surface of alumina is removed, and a necessary organic functional group is introduced. In addition, surface treatment is performed without the adsorbed moisture, and thus, even if alumina comes into contact with moisture (including being exposed to a high-humidity atmosphere) after the surface treatment, the quantity of free OH groups is small, so that moisture adsorption is inhibited.

The alumina particle material of the present disclosure has the necessary organic functional group introduced onto the surface, and has a necessary functionality. In particular, the surface treatment is performed in a state where the amount of adsorbed moisture is small, and thus, after the surface treatment, moisture is inhibited from being adsorbed onto the surface. Further, in a case where the alumina particle material is incorporated resin material and is used as a resin composition, moisture adsorbed on the alumina particle material is removed, so that the effect of inhibiting the impact on the resin material is also exhibited. An example of the impact on the resin material is the impact on curing in a case where an uncured resin precursor is used as the resin material.

### DESCRIPTION OF EMBODIMENT

An alumina particle material and a production method therefor, and an organic substance composition of the present disclosure will be described in detail based on an embodiment. The use of the alumina particle material of the present embodiment is not particularly limited, and the alumina particle material is preferably used as a filler incorporated into a resin composition for an electronic material by dispersing the alumina particle material in a resin material. The resin material is not particularly limited, and examples thereof include epoxy resin, urethane resin, and silicone resin.

Alumina as a main component of the alumina particle material of the present embodiment has high thermal conductivity, and is suitably used as a filler in a resin composition to be used for a thermally conductive material (TIM), an encapsulant, an underfill, and the like. Herein, regarding a numerical value described below, a range using the numerical value as the upper limit value or the lower limit value may be set, even if not particularly described. In this case, the range may include the numerical value or may not necessarily include the numerical value. Further, a range using another optional numerical value as the upper limit or the lower limit may be also set. In this case, the range may be set such that each of the set upper and lower limits is independently included or is not included.

### (Alumina Particle Material)

The alumina particle material of the present embodiment contains alumina as a main component. Containing alumina as a main component means containing 50% or more of alumina by mass. Preferably, 75% or more, 90% or more, 95% or more, or 99% or more of alumina by mass is contained, the entirety is formed of alumina except for unavoidable impurities, or other conditions may be used.

Alumina preferably has an α-phase content of less than 90%. The upper limit value for the α-phase content is, for example, 85%, 80%, 75%, or 70%. When alumina is exposed to high temperatures, the α-phase content is increased. For example, when alumina is exposed to a temperature of 1300° C. or higher, the α-phase content is increased to 90% or more. The alumina particle material of the present embodiment is produced by a production method including a heating step as described below. However, the heating temperature refers to a condition that hardly improves an α-phase content, and thus alumina has an α-phase content in the above-described range.

Examples of the material contained, other than alumina, include metal oxides such as silica, titania, and zirconia, and such a material may be contained as a crystal separate from alumina, or may be contained in an alumina crystal. Further, such a material may be a mixture of a particle material composed of alumina and a particle material composed of a material other than alumina.

The alumina particle material of the present embodiment has an organic functional group on a surface thereof. Examples of the organic functional group include a vinyl group, an amino group, an alkoxy group, a phenyl group, an aminophenyl group, an epoxy group, a methacrylic group, an acrylic group, a styryl group, an alkyl group, and an isocyanate group. The organic functional group is bonded to the surface of alumina.

Specifically, the organic functional group is directly bonded to an Al atom or an oxygen atom constituting alumina, or is bonded to the Al atom or the oxygen atom via a silicon atom, a titanium atom, an aluminum atom, or the like. For example, a silane coupling agent (silane compound), a titanium coupling agent (titanium compound), or an aluminate coupling agent (aluminum compound) each having an organic functional group that is desired to be introduced, is reacted to introduce the organic functional group.

In a case of introduction via a silane compound, the organic functional group is expected to be introduced to an Al atom constituting alumina in a chemical structure (Al—O—Si-organic functional group). In a case of introduction via a titanium compound, the organic functional group is expected to be introduced to an Al atom constituting alumina in a chemical structure (Al—O—Ti-organic functional group).

In the above chemical structure, a structure (Si-linker-organic functional group) may be used as a portion (Si-organic functional group). The linker is not particularly limited, and an organosiloxane group that has an alkylene group having about one to six carbon atoms, a methyl group, or an ethyl group is used.

In addition, aside from surface treatment using the silane coupling agent, a silyl group is also introduced using a silylating agent (silane compound). A plurality of silane compounds such as the silane coupling agent and the silylating agent may be used.

An introduction quantity of the organic functional groups is not particularly limited, and, with respect to the surface area of the alumina particle material (value measured by the BET method using nitrogen gas; the same applies to the following), is about 0.3 groups/nm² to 2.0 groups/nm², and 0.3 groups/nm² or 0.4 groups/nm² as the lower limit value, and 1.0 groups/nm², 1.5 groups/nm², or 2.0 groups/nm² as the upper limit value are used. The upper limit value and the lower limit value are combined as desired.

The alumina particle material of the present embodiment is preferably spherical. In particular, circularity thereof is 0.8 or more, 0.9 or more, 0.95 or more, or 0.99 or more. The circularity is calculated as a value obtained through (circularity)={4π×(area)÷(circumference)²} based on the area and the circumference of a particle observed in a photograph taken by using an SEM. The closer the value approaches 1, the more the shape becomes a perfect sphere. Specifically, the average value of 100 or more particles measured by using image processing software (Asahi Kasei Engineering Corporation: A-zou-kun), is used.

Active sites that react with an epoxy group present in an epoxy resin material are present on the surface of the alumina particle material, and the quantity of the reaction sites is evaluated based on an epoxy equivalent weight. The reaction between the surface of the alumina particle material and the epoxy resin material preferably occurs little as possible. Specifically, in the alumina particle material of the present embodiment, the epoxy equivalent weight is preferably 175 (g/eq) or less, more preferably 170 (g/eq) or less, and further preferably 165 (g/eq) or less.

The alumina particle material of the present embodiment is different from a conventional alumina particle material in a point that the reduction of the reaction sites has sufficiently progressed through surface treatment using a surface treatment agent. That is, since the surface treatment is performed in a state where the amount of moisture adsorbed on the surface is small, even if the amount of the surface-treatment-agent-derived material present on the surface is approximately the same, the extent of the reduction in the reaction sites is different.

In particular, the rate of increase in the epoxy equivalent weight after the alumina particle material is maintained in a heated state at 110° C. for 12 hours is preferably 8.0% or less. In particular, the upper limit value of the rate of increase in the epoxy equivalent weight is preferably 7.5%, 6.0%, 5.0%, 4.0%, 3.0%, 2.5%, 2.0%, 1.5%, or 1.0%. As for the heating condition and the method for measuring the epoxy equivalent weight, the measurement is carried out using a method used for Examples described below.

The alumina particle material of the present embodiment satisfies the following requirement (a). For reference, an alumina particle material (b) having a different volume average particle diameter is shown.

(a) A volume average particle diameter is 2.0 μm or less (preferably less than 0.5 μm), a specific surface area is 1.5 m²/g or more, a moisture content resulting after heating from 25° C. to 200° C. is 700 ppm or less by mass, and a dielectric loss tangent is 0.0075 or less. As the upper limit value of the volume average particle diameter, 1.8 μm, 1.6 μm, 1.5 μm, 1.4 μm, 1.3 μm, 1.2 μm, 1.1 μm, 1.0 μm, 0.9 μm, 0.8 μm, 0.7 μm, 0.6 μm, 0.49 μm, 0.48 μm, 0.47 μm, 0.45 μm, 0.44 μm, 0.43 μm, 0.42 μm, 0.41 μm, or 0.40 μm is used. When the particle diameter is smaller, the specific surface area also tends to be larger, so that the impact of moisture adsorbed on the surface increases.

Unless otherwise particularly limited herein, a specific surface area refers to a value obtained through measurement by the BET method using nitrogen gas. Unless otherwise particularly limited herein, a moisture content refers to a value obtained by measuring the moisture resulting when a weighed sample is heated from 25° C. to 200° C., by Karl Fischer Coulometric Titration by using a model CA310 device manufactured by Mitsubishi Chemical Analytech Co., Ltd.

The upper limit of the moisture content is 650 ppm, 600 ppm, 550 ppm, or 500 ppm. An example of the preferable upper limit value of the dielectric loss tangent is 0.0050, 0.0040, 0.0030, or 0.0025. The small volume average particle diameter allows the rate of moisture re-adsorption to increase. Unless an operation aimed at reducing a moisture content is performed, obtaining an alumina particle material reacted with a surface treatment agent is difficult at a moisture content equal to or lower than the moisture content specified in the present embodiment.

(b) A volume average particle diameter is 2.0 μm or more and 20 μm or less, a specific surface area is 0.2 m²/g or more and less than 1.5 m/g, a moisture content resulting after heating from 25° C. to 200° C. is 200 ppm or less by mass, and a dielectric loss tangent is 0.0020 or less.

The upper limit of the moisture content is 190 ppm, 150 ppm, 130 ppm, 110 ppm, 80 ppm, or 60 ppm. An example of the preferable upper limit value of the dielectric loss tangent is 0.0015, 0.0012, or 0.0010.

### (Method for Producing Alumina Particle Material)

The method for producing the alumina particle material of the present embodiment includes a raw particle material preparation step, a heating step, a surface treatment step, and another step to be selected as needed.

### Raw Particle Material Preparation Step

The raw particle material preparation step is a step of preparing a raw particle material containing alumina as a main component. The specific method for preparing the alumina particle material is not limited, and examples of the method include: a VMC method in which a powder material composed of metallic aluminum is fed into a high-temperature oxidizing atmosphere, deflagrated, and then rapidly cooled, whereby a raw particle material having a spherical shape and composed of alumina is prepared; and a melting method in which a particle material composed of alumina is fed into a high-temperature atmosphere, heated and melted, and then rapidly cooled whereby the particle material is spheroidized.

In the VMC method, a metal element corresponding to a metal oxide to be contained, other than alumina, is incorporated into aluminum to be used as the raw material. In the melting method, a material constituting an alumina particle material is used as a material to be subjected to the melting method. In addition, in the melting method, a raw particle material may be prepared by melting a granulated material having a large particle diameter and made from particles each having a small particle diameter. The raw particle material is preferably subjected to the heating step described below without being brought into contact with moisture. In addition, the same treatment as the surface treatment that is performed in the surface treatment step described below may be performed or may not be necessarily performed before the heating step.

### Heating Step

The heating step is a step of preparing a dried raw particle material by maintaining the raw particle material at 100° C. or higher for 5 minutes or more. The adsorbed moisture present on the surface of the raw particle material is removed through heating at 100° C. or higher. As an example of the lower limit value of the heating temperature, 80° C., 90° C., 100° C., 110° C., 120° C., 130° C., 140° C., 150° C., 160° C., 170° C., 180° C., 190° C., 200° C., 400° C., or 800° C. is used. As an example of the upper limit value thereof, 200° C., 210° C., 220° C., 230° C., 240° C., 250° C., 260° C., 270° C., 280° C., 290° C., 300° C., 310° C., 320° C., 330° C., 340° C., 350° C., 360° C., 370° C., 380° C., 390° C., 400° C., 500° C., 600° C., 700° C., 800° C., 900° C., or 1000° C., each of which is a temperature at which the raw particle material does not melt, is used. These upper limit values and these lower limit values are combined as desired. When the heating temperature reaches 200° C. or higher, bound water is also expected to be removed. Further, when the heating temperature exceeds 400° C., the dehydration reaction of the OH groups present on the surface of alumina is expected to progress.

The heating temperature may be maintained constant, increased, or decreased. The heating temperature may be increased or decreased gradually or in a step-like manner.

In order to achieve sufficient removal of adsorbed moisture, as an example of the lower limit value of the heating time, 5 minutes, 10 minutes, 20 minutes, or 30 minutes is used. A longer heating time is useful in removal of the adsorbed moisture, and a shorter heating time reduces the costs required for heating.

In the heating step, heating is preferably performed until the moisture content per gram, converted to the quantity of OH groups, becomes 5×10¹⁸ or less. In particular, as the upper limit of the quantity of OH groups, 1×10¹⁸, 2×10¹⁸, or 5×10¹⁸ is preferably used. Measurement of the quantity of OH groups is performed through calculation using (quantity of OH groups per gram)=c×(a/b), based on moisture content (a) subjected to the heating step, moisture content (b) not subjected to the heating step, and the quantity of hydroxyl groups (c) at that time.

The heating is preferably performed in a treatment vessel that prevents external moisture from entering or that has been sealed. Examples of the heating method include a method of heating the treatment vessel or the like from the outside, a method of introducing heated dry gas (dry air or the like) into the treatment vessel, and a method of performing irradiation with microwaves or the like. In addition, during heating, the pressure on the raw particle material may be reduced, or dry gas may be supplied to the raw particle material. Further, in order to effectively remove the desorbed adsorbed moisture, during heating, the raw particle material is preferably stirred or fluidized.

### Surface Treatment Step

The surface treatment step is a step of treating the dried raw particle material using a surface treatment agent to mask at least a portion of the OH groups present on a surface thereof. The OH groups present on the surface are assumed to be directly bonded to an Al atom in alumina constituting the alumina particle material.

The surface treatment is performed after heating in the heating step and before the adsorption of moisture on the surface becomes saturated. In a case where moisture has been adsorbed onto the surface, performing sufficient surface treatment is difficult. Thus, when the surface treatment is performed before the moisture content returns to that before the heating step, the higher effect of the surface treatment is exhibited than that in a case of no heating step.

Further, the surface treatment is preferably performed within a time period during which the temperature of the dried raw particle material does not fall below 80° C. Since the re-adsorption of moisture on the surface of the dried raw particle material progresses as the temperature decreases, the surface treatment is performed before the temperature decreases.

In addition, preferably, after the heating in the heating step, the dried raw particle material is maintained and cooled in a space having a limited present moisture content, and then the surface treatment is performed. Here, the limited present moisture content refers to a moisture content that does not allow the moisture content of the dried raw particle material to reach that of before the heating step even if all the present moisture has been adsorbed, or a moisture content that does not allow the moisture content of the dried raw particle material to reach that of before the heating step when the dried raw particle material has been maintained and cooled in the space. In particular, even if all the present moisture has been adsorbed, the moisture content is preferably equal to or less than the above-described upper limit for OH groups. Further, even if the moisture content is more than the above-described upper limit for OH groups, the surface treatment may be performed before the amount of the moisture exceeding the upper limit value is absorbed. Further, the dried raw particle material may be maintained and cooled in the space having a limited present moisture content, in operation in which the surface treatment is performed before the temperature decreases after the heating step as described above.

In the surface treatment step, remaining OH groups are masked by reacting the surface treatment agent with the OH groups. In this case, since the amount of moisture adsorbed on the surface is reduced, the interposition of water molecules between alumina and the surface treatment agent as in the conventional art is suppressed, so that the amount of the surface treatment agent directly reacted on the surface of alumina is increased. As the surface treatment agent, an agent that reacts with OH groups is used, and examples of the agent include silane compounds such as a silane coupling agent, and titanium compounds such as a titanium coupling agent. The surface treatment agent preferably has a suitable organic functional group. Since, as the organic functional group, the groups described above in the section for the alumina particle material of the present embodiment are used, the description is omitted. Specific examples of the surface treatment agent include a silane compound (silane coupling agent), a titanium compound (titanium coupling agent), and a hexamethyldisilazane (HMDS) each having such an organic functional group in a structure thereof. In the silane compound or the titanium compound, a silicon atom or a titanium atom and the organic functional group may be bonded directly or via the above-described linker.

The amount of the surface treatment agent is not particularly limited, and is preferably set to be sufficient to react with all the OH groups present on the surface of the dried raw particle material. For example, the amount is about 0.1% to 3.0% based on the mass of the dried raw particle material. For example, the lower limit value thereof is 0.2%, 0.3%, or 0.4%, and the upper limit value thereof is 2% or 2.5%. The upper limit value and the lower limit value are combined as desired.

Further, the surface treatment may be performed using a plurality of surface treatment agents. In a case where the plurality of surface treatment agents are used, the plurality of surface treatment agents may be divided into one portion or two or more portions, which may be reacted sequentially, or the plurality of surface treatment agents may be reacted all at once.

The surface treatment step is a step of performing surface treatment on the dried raw particle material in a state where the adsorbed moisture has been removed even a little through the heating step. After the heating step, as the temperature decreases, the moisture contained in the atmosphere is adsorbed onto the surface of the dried raw particle material. In addition, after the heating step, the moisture present in the atmosphere is re-adsorbed onto the dried raw particle material over time, and thus the surface treatment is preferably performed as rapidly as possible after the heating step has been performed.

In the surface treatment step, either one of: performing the surface treatment before the temperature decreases; or reducing the moisture content contained in the atmosphere to be lower than that in the surrounding environment to decrease the rate of moisture adsorption onto the surface when the temperature has decreased, and then rapidly performing the surface treatment before moisture is adsorbed, is preferably selected. In addition, the surface treatment is preferably performed in a state where the moisture content contained in the atmosphere is made lower than that in the surrounding environment. A method for reducing the moisture content contained in the atmosphere to be lower than that in the surrounding environment is realized by using a refined gas with a low moisture content as a part or the entirety of the atmosphere, using dehumidified air, or reducing the pressure of the atmosphere.

The surface treatment agent is brought into contact with the surface of the dried raw particle material by a suitable method. The surface treatment agent may be mixed with the dried raw particle material as it is, or may be dissolved in a suitable solvent and then mixed with the dried raw particle material. In a case where the surface treatment agent is a compound that needs to be hydrolyzed such as a silane compound or a titanium compound, the surface treatment agent is hydrolyzed by the moisture present in the atmosphere, the moisture present on the surface of the dried raw particle material, or the moisture contained in the solvent in the case of the surface treatment agent dissolved in the solvent. The surface treatment agent may be mixed while the dried raw particle material is being stirred.

After the surface treatment is performed, the dried raw particle material may be heated, but is not particularly limited thereto. For example, the dried raw particle material may be heated while the surface treatment agent is being mixed, or may be heated after mixing. As an example of the heating temperature, 80° C. or higher, 100° C. or higher, 120° C. or higher, 140° C. or higher, or 160° C. or higher is selected.

### Other Steps

After the surface treatment step, avoiding contact with water is preferable. Even if the dried raw particle material has come into contact with water, a re-heating step of heating at 100° C. or higher again after the contact is preferably provided. An example of the heating temperature in the re-heating step is 120° C., 150° C., and 200° C.

After the surface treatment step or the heating step, a crushing step of crushing obtained particles is preferably provided. In the crushing step, a grinding operation by a jet mill or the like may be used.

### (Organic Substance Composition)

An organic substance composition of the present embodiment includes the alumina particle material of the present embodiment described above, and a dispersion medium for dispersing the alumina particle material. The blending amount of the alumina particle material in the organic substance composition of the present embodiment is not particularly limited, and, as the lower limit of the blending amount, 60%, 70%, 80%, or 90% based on the total mass is used.

The dispersion medium is composed of at least one of an organic resin material and an organic solvent. In a case where the organic resin material is used as the dispersion medium, the organic resin material is suitably used for a resin composition for electronic equipment such as an encapsulant, an underfill, and a substrate for a semiconductor device. In a case where the organic solvent is used as the dispersion medium, the organic solvent is suitably used for a slurry composition or the like for supplying a silica particle material into a resin material.

As the organic resin material, both a thermosetting resin and a thermoplastic resin may be used, and a resin that has not been cured may also be used. Examples of the organic resin material include epoxy resin, silicone resin, urea resin, and acrylic resin. Examples of the organic solvent include ketones such as methyl ethyl ketone and acetone, hydrocarbons such as hexane and octane, alcohols such as methanol and ethanol, and aromatic hydrocarbons such as toluene and xylene.

### EXAMPLES

An alumina particle material and a method for producing the alumina particle material according to the present disclosure will be described in detail based on Examples.

### (Preliminary Test)

A particle material composed of alumina having a volume average particle diameter of 0.2 μm and a specific surface area of 6.6 m²/g was used as a test sample. The test sample was prepared by the VMC method. The test sample was heated in an ambient atmosphere at 200° C. for 480 minutes, and was cooled in the ambient atmosphere at normal temperature. The moisture content of the test sample was measured when the temperature of the test sample became 200° C. (immediately after heating), 80° C. (45 minutes elapsed after heating), and normal temperature (25° C.: 90 minutes elapsed after heating), and was measured when 3 hours elapsed after heating, when 4.5 hours elapsed after heating, and when 6 hours elapsed after heating, and each measured moisture content is shown in Table 1.

TABLE 1

| Elapsed time | Test sample | Moisture |
|---|---|---|
| after heating | temperature | content |
| (h) | (° C.) | (ppm) |
| 0 | 200 | 222 |
| 0.75 | 80 | 952 |
| 1.5 | 25 | 1767 |
| 3 | 25 | 1970 |
| 4.5 | 25 | 2121 |
| 6 | 25 | 2173 |

As is obvious from Table 1, the moisture content was found to increase as the temperature of the test sample approached normal temperature. The moisture content was found to rapidly increase when the temperature of the test sample decreased, and the change in moisture content was found to become very little when the change in temperature stopped. That is, the moisture content was found to be rapidly follow the decrease in temperature, and maintaining low moisture content at a high temperature after heating or performing surface treatment described below after heating was found to be necessary, in order to maintain the moisture content low.

### (Test)

### Examples 1 to 10

Particle materials each composed of alumina having a volume average particle diameter and a specific surface area shown in Table 2 were used as raw particle materials (raw particle material preparation step). Each raw particle material was prepared by the VMC method. The raw particle material was heated at 160° C. in a vacuum atmosphere for 30 minutes, to obtain a dried raw particle material (heating step).

Surface treatment was performed using a surface treatment agent of each Example shown in Table 2 under the condition (the temperature of the dried raw particle material was 80° C.) after 10 minutes elapsed after the heating step.

### Comparative Examples 1 to 10

A test sample of each Comparative Example was an alumina particle material that corresponds to that of each Example and that was prepared without performing the heating step.

### Evaluation (Moisture Content, Viscosity of Resin Composition, Dielectric Loss Tangent, Particle Diameter, and Specific Surface Area)

The moisture content, the viscosity of the resin composition, the dielectric loss tangent, the particle diameter, and the specific surface area were measured for some of the test samples of Examples and Comparative Examples and are shown in Table 2.

Regarding measurement of the moisture content, the moisture content resulting after heating from 25° C. to 200° C. and the moisture content resulting after heating from 200° C. to 550° C. were measured, and the moisture content per unit mass resulting under each condition was calculated and is shown in Table 2. The moisture content resulting after heating from 200° C. to 550° C. was measured under the same conditions as measurement of the moisture content resulting after heating from 25° C. to 200° C., except that the start temperature and the end temperature of the heating temperature were changed. For each of the raw particle materials and the dried raw particle materials of Examples, the moisture content resulting after heating from 25° C. to 200° C. was also measured, and the moisture content per unit mass resulting under the condition was calculated.

For the test sample of each of Examples and Comparative Examples, a slurry-like resin composition (organic substance composition) was prepared through mixing so as to achieve 75 mass % within the resin material shown in Table 2. The viscosity of the prepared resin composition of each Example was measured by using a rheometer. The viscosity measurement was performed under the conditions of shear rates of 0.1/s and 1/s.

The value of the dielectric loss tangent of the test sample of each of Examples and Comparative Examples was measured by using a network analyzer.

The particle diameter was measured as the median diameter, D50, by the laser diffraction/scattering method by using LA960 manufactured by HORIBA, Ltd. The specific surface area was measured at normal temperature (25° C.) by the BET method using nitrogen gas.

TABLE 2

| | | Specific | Before surface treatment | | | | | |
|---|---|---|---|---|---|---|---|---|
| | Particle | surface | Moisture | Moisture | Dielectric | | | |
| | diameter | area | content | content | loss | | Viscosity | Viscosity |
| | μm | m²/g | (200° C.) | (550° C.) | tangent | Resin | (0.1/s) | (1/s) |
| Ex. 1 | 0.2 | 6.6 | 1919 | 685 | 0.0200 | — | | |
| Ex. 2 | 0.2 | 6.6 | 1919 | 685 | 0.0200 | Epoxy | Un-measurable | Un-measurable |
| Ex. 3 | 0.2 | 6.6 | 1919 | 685 | 0.0200 | Silicone | 2527 | 900 |
| Ex. 4 | 0.2 | 6.6 | 1919 | 685 | 0.0200 | Silicone | 2527 | 900 |
| Ex. 5 | 9.9 | 1.2 | 483 | — | 0.0027 | Epoxy | 89 | 50 |
| Ex. 6 | 11.2 | 0.3 | 78 | | 0.0006 | Epoxy | 62 | 54 |
| Ex. 7 | 3.1 | 0.8 | 303 | | 0.0019 | Epoxy | 330 | 173 |
| Ex. 8 | 9.9 | 1.2 | 483 | | 0.0027 | Epoxy | 89 | 50 |
| Ex. 9 | 1.5 | 1.3 | 504 | | 0.0073 | Epoxy | 643 | 242 |
| Ex. 10 | 1.5 | 1.3 | 504 | | 0.0073 | Epoxy | 643 | 242 |
| Comp. | 0.2 | 6.6 | 1919 | 685 | 0.0200 | — | | |
| Ex. 1 | | | | | | | | |
| Comp. | 0.2 | 6.6 | 1919 | 685 | 0.0200 | Epoxy | Un-measurable | Un-measurable |
| Ex. 2 | | | | | | | | |
| Comp. | 0.2 | 6.6 | 1919 | 685 | 0.0200 | Silicone | 2527 | 900 |
| Ex. 3 | | | | | | | | |
| Comp. | 0.2 | 6.6 | 1919 | 685 | 0.0200 | Silicone | 2527 | 900 |
| Ex. 4 | | | | | | | | |
| Comp. | 9.9 | 1.2 | 483 | — | 0.0027 | — | | |
| Ex. 5 | | | | | | | | |
| Comp. | 11.2 | 0.3 | 78 | | 0.0006 | — | | |
| Ex. 6 | | | | | | | | |
| Comp. | 3.1 | 0.8 | 303 | | 0.0019 | — | | |
| Ex. 7 | | | | | | | | |
| Comp. | 9.9 | 1.2 | 483 | | 0.0027 | Epoxy | 89 | 50 |
| Ex. 8 | | | | | | | | |
| Comp. | 1.5 | 1.3 | 504 | | 0.0073 | Epoxy | 643 | 242 |
| Ex. 9 | | | | | | | | |
| Comp. | 1.5 | 1.3 | 504 | | 0.0073 | Epoxy | 643 | 242 |
| Ex. 10 | | | | | | | | |

| | | | | | | | | | Moisture |
|---|---|---|---|---|---|---|---|---|---|
| | | | | | | | | | content |
| | After surface treatment | | | | | | | | after |
| | | | | | | | | Whether or | drying and |
| | | | | | | | | not dried | before |
| | Surface | Moisture | Moisture | | | | | before | surface |
| | treatment | content | content | Dielectric | | Viscosity | Viscosity | surface | treatment |
| | type | (200° C.) | (550° C.) | loss tangent | Resin | (0.1/s) | (1/s) | treatment | (200° C.) |
| Ex. 1 | Vinyl- | 469 | 322 | 0.0013 | — | | | Dried | 386 |
| | silane | | | | | | | | |
| Ex. 2 | Amino- | 464 | 208 | 0.0074 | Epoxy | 305 | 2694 | Dried | 387 |
| | silane | | | | | | | | |
| Ex. 3 | Propyl- | 633 | 248 | 0.0020 | Silicone | 1332 | 269 | Dried | 395 |
| | methoxy- | | | | | | | | |
| | silane | | | | | | | | |
| Ex. 4 | Alkoxy- | 578 | 29 | 0.0024 | Silicone | 1631 | 228 | Dried | 385 |
| | modified | | | | | | | | |
| | silicone | | | | | | | | |
| Ex. 5 | Vinyl- | 183 | — | 0.0005 | — | | | Dried | 196 |
| | silane | | | | | | | | |
| Ex. 6 | Vinyl- | 47 | | 0.0004 | — | | | Dried | 89 |
| | silane | | | | | | | | |
| Ex. 7 | Vinyl- | 127 | | 0.0013 | — | | | Dried | 349 |
| | silane | | | | | | | | |
| Ex. 8 | Amino- | 183 | | 0.0005 | Epoxy | 18 | 19 | Dried | 196 |
| | silane | | | | | | | | |
| Ex. 9 | Vinyl- | 152 | | 0.0023 | Epoxy | 32 | 75 | Dried | 420 |
| | silane | | | | | | | | |
| Ex. 10 | Amino- | 155 | | 0.0025 | Epoxy | 46 | 93 | Dried | 433 |
| | silane | | | | | | | | |
| Comp. | Vinyl- | 1050 | — | 0.0039 | — | | | Not dried | — |
| Ex. 1 | silane | | | | | | | | |
| Comp. | Amino- | 1463 | 320 | 0.0176 | Epoxy | 31284 | 7935 | Not dried | — |
| Ex. 2 | silane | | | | | | | | |
| Comp. | Propyl- | 1058 | 214 | 0.0048 | Silicone | 2722 | 361 | Not dried | — |
| Ex. 3 | methoxy- | | | | | | | | |
| | silane | | | | | | | | |
| Comp. | Alkoxy- | — | | | Silicone | 2259 | 359 | Not dried | — |
| Ex. 4 | modified | | | | | | | | |
| | silicone | | | | | | | | |
| Comp. | Vinyl- | 236 | — | 0.0011 | — | | | Not dried | — |
| Ex. 5 | silane | | | | | | | | |
| Comp. | Vinyl- | 40 | | 0.0010 | — | | | Not dried | — |
| Ex. 6 | silane | | | | | | | | |
| Comp. | Vinyl- | 182 | | 0.0016 | — | | | Not dried | — |
| Ex. 7 | silane | | | | | | | | |
| Comp. | Amino- | 236 | | 0.0011 | Epoxy | 20 | 21 | Not dried | — |
| Ex. 8 | silane | | | | | | | | |
| Comp. | Vinyl- | 222 | | 0.0029 | Epoxy | 78 | 100 | Not dried | — |
| Ex. 9 | silane | | | | | | | | |
| Comp. | Amino- | 232 | | 0.0029 | Epoxy | 89 | 112 | Not dried | — |
| Ex. 10 | silane | | | | | | | | |

The unit for all viscosities is Pa·s, and the unit for all moisture contents is ppm.

As is obvious from Table 2, each test sample of Examples was found to have a lower moisture content, a lower dielectric loss tangent, and a lower viscosity in the resin than each test sample of corresponding Comparative Examples subjected to no heating step. In addition, each test sample of Examples also had a lower dielectric loss tangent than each test sample of corresponding Comparative Examples.

That is, the alumina particle material having a reduced moisture content obtained through the heating step before the surface treatment was found to achieve a lower dielectric loss tangent and further, a lower viscosity of the resin composition incorporated into the resin material.

### Evaluation (Epoxy Equivalent Weight)

With respect to an alumina particle material (AO-502 produced by ADMATECHS COMPANY LIMITED, D50=0.2 to 0.3 μm, specific surface area of 6.5 to 9.0 m²/g) as a test sample, an epoxy equivalent weight was measured for each sample of Test Examples subjected to a heating step and a surface treatment step under conditions shown in Table 3.

The heating step was performed at each temperature shown in Table 3 for 60 minutes, and immediately after the heating step, an HMDS surface treatment step was performed. Measurement of the epoxy equivalent weight was performed on a mixture obtained by mixing 40 parts by mass of the test sample and 60 parts by mass of an epoxy resin (ZX-1059 (produced by NIPPON STEEL Chemical & Material Co., Ltd.)), immediately after the surface treatment step, immediately after the mixing (0 h), and after the mixture was maintained for 12 hours and 24 hours while being heated at 110° C. The heating at 110° C. was performed by blowing, onto the sample, air obtained by heating air having a temperature of 25° C. and a relative humidity of 60% to 110° C.

Measurement of the epoxy equivalent weight was also performed on the epoxy resin (ZX-1059 (produced by NIPPON STEEL Chemical & Material Co., Ltd.)) alone. The results are shown in Table 3. In Table 3, the value of the epoxy equivalent weight obtained by measuring each test sample as it was, as well as the value converted to that corresponding to the resin alone, are shown. The conversion to the value corresponding to the resin alone is performed by multiplying each measurement value by the mass ratio (0.6) of the resin mixed.

The specific epoxy equivalent weight was measured by the following operations.
1. Hydrochloric acid-dioxane added as a control sample (Blank) was titrated with sodium hydroxide;
2. A predetermined amount (W) of a test sample to be measured was weighed into an Erlenmeyer flask, and an excess quantity of hydrochloric acid-dioxane solution was added to dissolve the sample, whereby a test solution was obtained;
3. A phenolphthalein solution was added, and the amount of hydrochloric acid-dioxane remaining in the test solution was titrated with sodium hydroxide by using a burette;
4. Using the difference between the amount of sodium hydroxide (Vb) equivalent to an addition amount of hydrochloric acid-dioxane and the amount of sodium hydroxide (Vs) equivalent to the amount of hydrochloric acid-dioxane remaining in the test solution, the epoxy equivalent weight was calculated by the following formula.

$$( Epoxy equivalent weight ) = 10000 W / f ( Vb - Vs ) [ g / mol ]$$

f: titration factor=1

TABLE 3

| | Heating | | | | | | | | |
|---|---|---|---|---|---|---|---|---|---|
| | temperature | Addition amount | | Sample | | Sample | | Sample | |
| | (° C.) | of surface | | amount | NaOH | amount | NaOH | amount | NaOH |
| FC | in heating | treatment agent | Heating time | | titer | | titer | | titer |
| [wt %] | step | (mass %) | at 110° C. | n1 | | n2 | | n3 | |
| Resin | — | | 0 h | 0.1142 | 13.06 | — | — | — | — |
| alone | | | | | | | | | |
| Test | No heating | No surface | | 0.1242 | 15.69 | — | — | — | — |
| Ex. 1 | step | treatment step | | | | | | | |
| Test | No heating | 0.045 | | 0.1200 | 15.80 | — | — | — | — |
| Ex. 2 | step | | | | | | | | |
| Test | No heating | 0.090 | | 0.1191 | 15.80 | — | — | — | — |
| Ex. 3 | step | | | | | | | | |
| Test | No heating | 0.120 | | 0.1284 | 15.53 | — | — | — | — |
| Ex. 4 | step | | | | | | | | |
| Test | 200 | 0.045 | | 0.1299 | 15.50 | — | — | — | — |
| Ex. 5 | | | | | | | | | |
| Test | 200 | 0.090 | | 0.1229 | 15.67 | — | — | — | — |
| Ex. 6 | | | | | | | | | |
| Test | 200 | 0.120 | | 0.1269 | 15.51 | — | — | — | — |
| Ex. 7 | | | | | | | | | |
| Test | 900 | 0.045 | | 0.1191 | 15.74 | — | — | — | — |
| Ex. 8 | | | | | | | | | |
| Blank | | | | — | 20.29 | — | | — | |
| Resin | — | | 12 h | 0.1240 | 12.70 | 0.1211 | 11.90 | 0.1091 | 12.78 |
| alone | | | | | | | | | |
| Test | No heating | No surface | | 0.1221 | 15.92 | 0.1255 | 15.00 | 0.1283 | 15.3 |
| Ex. 1 | step | treatment step | | | | | | | |
| Test | No heating | 0.045 | | 0.1257 | 15.78 | 0.1274 | 14.92 | 0.1304 | 15.28 |
| Ex. 2 | step | | | | | | | | |
| Test | No heating | 0.090 | | 0.1239 | 15.72 | 0.1233 | 15.13 | 0.1255 | 15.34 |
| Ex. 3 | step | | | | | | | | |
| Test | No heating | 0.120 | | 0.1196 | 15.72 | 0.1216 | 15.01 | 0.127 | 15.36 |
| Ex. 4 | step | | | | | | | | |
| Test | 200 | 0.045 | | 0.1151 | 15.90 | 0.1252 | 14.59 | 0.1228 | 14.97 |
| Ex. 5 | | | | | | | | | |
| Test | 200 | 0.090 | | 0.1135 | 15.91 | 0.1168 | 14.74 | 0.1175 | 15.18 |
| Ex. 6 | | | | | | | | | |
| Test | 200 | 0.120 | | 0.1199 | 15.63 | 0.1216 | 15.11 | 0.1134 | 15.21 |
| Ex. 7 | | | | | | | | | |
| Test | 900 | 0.045 | | 0.1231 | 15.59 | 0.1202 | 14.91 | 0.1188 | 15.11 |
| Ex. 8 | | | | | | | | | |
| Blank | | | | — | 20.03 | — | 19.17 | — | 19.51 |
| Resin | — | | 24 h | 0.1084 | 13.69 | 0.1114 | 13.20 | 0.1119 | 13.08 |
| alone | | | | | | | | | |
| Test | No heating | No surface | | 0.1296 | 16.12 | 0.1357 | 15.83 | 0.1262 | 15.49 |
| Ex. 1 | step | treatment step | | | | | | | |
| Test | No heating | 0.045 | | 0.1294 | 16.09 | 0.1279 | 15.68 | 0.1311 | 15.50 |
| Ex. 2 | step | | | | | | | | |
| Test | No heating | 0.090 | | 0.1307 | 15.89 | 0.1263 | 15.71 | 0.1299 | 15.42 |
| Ex. 3 | step | | | | | | | | |
| Test | No heating | 0.120 | | 0.1278 | 16.12 | 0.1304 | 15.33 | 0.1267 | 15.53 |
| Ex. 4 | step | | | | | | | | |
| Test | 200 | 0.045 | | 0.1190 | 16.03 | 0.1193 | 15.58 | 0.1188 | 15.43 |
| Ex. 5 | | | | | | | | | |
| Test | 200 | 0.090 | | 0.1195 | 15.89 | 0.1208 | 15.59 | 0.1214 | 15.24 |
| Ex. 6 | | | | | | | | | |
| Test | 200 | 0.120 | | 0.1167 | 16.03 | 0.1213 | 15.48 | 0.1207 | 15.35 |
| Ex. 7 | | | | | | | | | |
| Test | 900 | 0.045 | | 0.1283 | 15.64 | 0.1277 | 15.4 | 0.1268 | 15.38 |
| Ex. 8 | | | | | | | | | |

| | | | | | | |
|---|---|---|---|---|---|---|
| Blank | — | 20.34 | — | 20.00 | — | 19.76 |

| | Epoxy equivalent weight [g/mol] | | | | | | Epoxy equivalent weight | | | | |
|---|---|---|---|---|---|---|---|---|---|---|---|
| | | | | | | Rate of | value converted in terms | | | | |
| | | | | | | increase | of resin alone [g/mol] | | | | |
| FC | | | | | Standard | (%) after | | | | | Standard |
| [wt %] | n1 | n2 | n3 | Average | deviation | heating | n1 | n2 | n3 | Average | deviation |
| Resin | 157.95 | — | — | 157.95 | — | — | 157.95 | — | — | 158 | — |
| alone | | | | | | | | | | | |
| Test | 270.00 | — | — | 270.00 | — | — | 162.00 | — | — | 162 | — |
| Ex. 1 | | | | | | | | | | | |
| Test | 267.26 | — | — | 267.26 | — | — | 160.36 | — | — | 160 | — |
| Ex. 2 | | | | | | | | | | | |
| Test | 265.26 | — | — | 265.26 | — | — | 159.15 | — | — | 159 | — |
| Ex. 3 | | | | | | | | | | | |
| Test | 269.75 | — | — | 269.75 | — | — | 161.85 | — | — | 162 | — |
| Ex. 4 | | | | | | | | | | | |
| Test | 271.19 | — | — | 271.19 | — | — | 162.71 | — | — | 163 | — |
| Ex. 5 | | | | | | | | | | | |
| Test | 266.02 | — | — | 266.02 | — | — | 159.61 | — | — | 160 | — |
| Ex. 6 | | | | | | | | | | | |
| Test | 265.48 | — | — | 265.48 | — | — | 159.29 | — | — | 159 | — |
| Ex. 7 | | | | | | | | | | | |
| Test | 261.76 | — | — | 261.76 | — | — | 157.05 | — | — | 157 | — |
| Ex. 8 | | | | | | | | | | | |
| | — | | | | | | — | | | | |
| Resin | 169.17 | 166.57 | 162.11 | 165.95 | 3.57 | — | 169.17 | 166.57 | 162.11 | 166 | 2.91 |
| alone | | | | | | | | | | | |
| Test | 297.08 | 300.96 | 304.75 | 300.93 | 3.84 | 11.5 | 178.25 | 180.58 | 182.85 | 181 | 1.88 |
| Ex. 1 | | | | | | | | | | | |
| Test | 295.76 | 299.76 | 308.27 | 301.27 | 6.39 | 12.7 | 177.46 | 179.86 | 184.96 | 181 | 3.13 |
| Ex. 2 | | | | | | | | | | | |
| Test | 287.47 | 305.20 | 300.96 | 297.88 | 9.26 | 12.3 | 172.48 | 183.12 | 180.58 | 179 | 4.53 |
| Ex. 3 | | | | | | | | | | | |
| Test | 277.49 | 292.31 | 306.02 | 291.94 | 14.27 | 8.2 | 166.50 | 175.38 | 183.61 | 175 | 6.99 |
| Ex. 4 | | | | | | | | | | | |
| Test | 278.69 | 273.36 | 270.48 | 274.18 | 4.16 | 1.1 | 167.22 | 164.02 | 162.29 | 165 | 2.04 |
| Ex. 5 | | | | | | | | | | | |
| Test | 275.49 | 263.66 | 271.36 | 270.17 | 6.00 | 1.6 | 165.29 | 158.19 | 162.82 | 162 | 2.94 |
| Ex. 6 | | | | | | | | | | | |
| Test | 272.50 | 276.36 | 263.72 | 270.86 | 6.48 | 2.0 | 163.50 | 165.82 | 158.23 | 163 | 3.17 |
| Ex. 7 | | | | | | | | | | | |
| Test | 277.25 | 282.16 | 270.00 | 276.47 | 6.12 | 5.6 | 166.35 | 169.30 | 162.00 | 166 | 3.00 |
| Ex. 8 | | | | | | | | | | | |
| | — | | | | | | — | | | | |
| Resin | 163.01 | 163.82 | 167.51 | 164.78 | 2.40 | — | 163.01 | 163.82 | 167.51 | 165 | 1.96 |
| alone | | | | | | | | | | | |
| Test | 307.11 | 325.42 | 295.55 | 309.36 | 15.06 | 14.6 | 184.27 | 195.25 | 177.33 | 186 | 7.38 |
| Ex. 1 | | | | | | | | | | | |
| Test | 304.47 | 296.06 | 307.75 | 302.76 | 6.03 | 13.3 | 182.68 | 177.64 | 184.65 | 182 | 2.95 |
| Ex. 2 | | | | | | | | | | | |
| Test | 293.71 | 294.41 | 299.31 | 295.81 | 3.05 | 11.5 | 176.22 | 176.64 | 179.59 | 177 | 1.50 |
| Ex. 3 | | | | | | | | | | | |
| Test | 302.84 | 279.23 | 299.53 | 293.87 | 12.78 | 8.9 | 181.71 | 167.54 | 179.72 | 176 | 6.26 |
| Ex. 4 | | | | | | | | | | | |
| Test | 276.10 | 269.91 | 274.36 | 273.46 | 3.19 | 0.8 | 165.66 | 161.95 | 164.62 | 164 | 1.56 |
| Ex. 5 | | | | | | | | | | | |
| Test | 268.54 | 273.92 | 268.58 | 270.35 | 3.10 | 1.6 | 161.12 | 164.35 | 161.15 | 162 | 1.52 |
| Ex. 6 | | | | | | | | | | | |
| Test | 270.77 | 268.36 | 273.70 | 270.94 | 2.67 | 2.1 | 162.46 | 161.02 | 164.22 | 163 | 1.31 |
| Ex. 7 | | | | | | | | | | | |
| Test | 272.98 | 277.61 | 289.50 | 280.03 | 8.52 | 7.0 | 163.79 | 166.57 | 173.70 | 168 | 4.17 |
| Ex. 8 | | | | | | | | | | | |

| | |
|---|---|
| — | — |

As is obvious from Table 3, when not heated at 110° C., the epoxy equivalent weights were approximately the same regardless of the heating temperature or the presence or absence of the heating step. However, as the heating time at 110° C. increased, the test samples of Test Examples 2 to 4 subjected to only the surface treatment step each had a smaller epoxy equivalent weight than that of Test Example 1 subjected to neither the heating step nor the surface treatment step. In addition, the larger the addition amount of the surface treatment agent in the surface treatment step was, the smaller the epoxy equivalent weight became. In Test Examples 5 to 8 subjected to both the heating step and the surface treatment step, each epoxy equivalent weight became even smaller. Here, when Test Example 5 and Test Example 8 different only in the temperature of the heating step were compared, Test Example 5 and Test Example 8 had no significant difference therebetween, so that a sufficient effect was found to be exhibited as long as the heating temperature was 200° C. or higher.

That is, by performing, after performing the heating step of the present disclosure, the surface treatment step rapidly before re-adsorption of moisture progresses, the reaction sites related to the increase in the epoxy equivalent weight were reduced without being hindered by moisture adsorbed on the surface.

The rate of increase in the epoxy equivalent weight before and after the heating at 110° C. was maintained less than 8% through the heating step. In addition, the smaller the treatment amount of the surface treatment agent was, within 0.045%, 0.090%, and 0.120%, the smaller the increase in the epoxy equivalent weight due to the heating at 110° C. was.

Although not shown in detail, the test sample that was cooled to room temperature in an air atmosphere after the heating step and then was subjected to the surface treatment, indicated approximately the same epoxy equivalent weight as that subjected to no heating step.

Through the above-described results, the increase in the epoxy equivalent weight over time has been shown to be inhibited by performing the surface treatment, and further the increase in the epoxy equivalent weight over time was found to be further inhibited by performing the heating step before the surface treatment step.

(Examination of Elapsed Time when Surface Treatment Step is Performed after Heating Step)

### Comparative Example 11

An alumina particle material prepared by the same method as the method for producing the test sample of Example 1 except that the test sample was cooled to 25° C. in an air atmosphere before the surface treatment step was performed after the heating step, was used as a test sample of this Comparative Example. As a result, a moisture content, a dielectric loss tangent, and a viscosity that were approximately the same as those of Comparative Example 1 corresponding to Example 1, were indicated. According to this result, the effect obtained by performing the heating step was found to be reduced due to moisture being re-adsorbed when, after drying, the test sample was cooled in an atmosphere in which a humidity was not 0%. That is, the effect due to the heating step was shown to decrease if the moisture content returned to the previous level thereof even when the heating step was performed.

1. A method for producing an alumina particle material, comprising:
a raw particle material preparation step of preparing a raw particle material containing alumina as a main component;
a heating step of preparing a dried raw particle material by maintaining the raw particle material at 100° C. or higher and 300° C. or lower for 5 minutes or more; and
a surface treatment step of treating the dried raw particle material subjected to the heating step and having less moisture adsorbed on a surface thereof than that before the heating step, using a surface treatment agent, to mask at least a portion of OH groups present on the surface.

2. The method for producing the alumina particle material according to claim 1, wherein a heating temperature in the heating step is 150° C. or higher.

3. The method for producing the alumina particle material according to claim 1, wherein
after the heating step and before the surface treatment step, at least one of conditions (1) and (2) is maintained:
(1) being maintained and cooled in a space having a limited present moisture content; and
(2) being naturally cooled within a time period during which a temperature does not fall below 80° C.

4. The method for producing the alumina particle material according to claim 2, wherein
after the heating step and before the surface treatment step, at least one of conditions (1) and (2) is maintained:
(1) being maintained and cooled in a space having a limited present moisture content; and
(2) being naturally cooled within a time period during which a temperature does not fall below 80° C.

5. The method for producing the alumina particle material according to claim 1, wherein
after the surface treatment step, contact with water is avoided, or
a re-heating step of heating at 100° C. or higher again after the contact with water is provided.

6. The method for producing the alumina particle material according to claim 2, wherein
after the surface treatment step, contact with water is avoided, or
a re-heating step of heating at 100° C. or higher again after the contact with water is provided.

7. The method for producing the alumina particle material according to claim 1, wherein
the heating step is performed until a moisture content per gram, converted to a quantity of OH groups, becomes 5×10¹⁸ or less.

8. The method for producing the alumina particle material according to claim 2, wherein
the heating step is performed until a moisture content per gram, converted to a quantity of OH groups, becomes 5×10¹⁸ or less.

9. An alumina particle material which is spherical and contains alumina as a main component, wherein
a volume average particle diameter is 2.0 μm or less, a specific surface area is 1.5 m²/g or more, an α-phase content is less than 90%,
a moisture content resulting after heating from 25° C. to 200° C. is 700 ppm or less by mass,
a dielectric loss tangent is 0.0075 or less, and
the alumina particle material has an organic functional group on a surface thereof.

10. The alumina particle material according to claim 9, wherein the volume average particle diameter is less than 0.5 μm.

11. The alumina particle material according to claim 9, wherein a rate of increase in an epoxy equivalent weight after being maintained in a heated state at 110° C. for 12 hours is 8.0% or less.

12. An organic substance composition comprising:
the alumina particle material according to claim 9; and
a dispersion medium composed of at least one of an organic resin material and an organic solvent for dispersing the alumina particle material.

13. An organic substance composition comprising:
the alumina particle material according to claim 10; and
a dispersion medium composed of at least one of an organic resin material and an organic solvent for dispersing the alumina particle material.

14. An organic substance composition comprising:
the alumina particle material according to claim 11; and
a dispersion medium composed of at least one of an organic resin material and an organic solvent for dispersing the alumina particle material.
